(19) United States
(12) Patent Application Publication
(10) Pub. No.: US 2020/0234302 A1
(43) Pub. Date: Jul. 23, 2020

(54) PASSWORD VERIFICATION

(71) Applicant: INTERNATIONAL BUSINESS MACHINES CORPORATION, ARMONK, NY (US)

(72) Inventors: Yong Yin, BEIJING (CN); Qi Li, BEIJING (CN); Jia Yu, BEIJING (CN); Xiao Ling Chen, BEIJING (CN); Zhan Peng Huo, BEIJING (CN)

(21) Appl. No.: 16/254,642

(22) Filed: Jan. 23, 2019

(51) Int. Cl. G06Q 20/40; H04L 29/06

(52) U.S. Cl. CPC G06Q 20/4014; H04L 63/083

(57) ABSTRACT

A computer-implemented method, computer program product and system for password verification are provided. A preset password and at least one condition for applying the preset password is received from device of a user. It is then determined whether the preset password is eligible. Responsive to the preset password being eligible, the preset password is registered. An input password from a device of a vendor can, therefore, be verified based on the registered preset password.

### BACKGROUND

The present invention generally relates to security and more specifically, relates to password verification.

Increasingly, applications and services require identity authentication by scanning two-dimensional code or inputting the digital password which is sent by the applications/services to users' smartphone. If the device that is required during authentication is unavailable, for example the smartphone is out of power, the applications/services will also become unavailable which brings inconvenience and even trouble to the user.

### SUMMARY

Example embodiments of the present disclosure provide a method, a system, and a computer program product for password verification.

In an aspect, a computer-implemented method for password verification is provided. In this method, a preset password and at least one condition for applying the preset password is received from a device of a user. It is then determined whether the preset password is eligible. Responsive to the preset password being eligible, the preset password can be registered. An input password from a device of a vendor can, therefore, be verified based on the registered preset password.

Other embodiments and aspects, including but not limited to, computer systems and computer program products, are described in detail herein and are considered a part of the claimed invention.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE SEVERAL VIEWS OF THE DRAWINGS

With reference to the more detailed description on the accompanying drawings, the embodiments of the present disclosure will become more apparent. The same reference generally refers to the same components in the embodiments of the present disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 illustrates an example flowchart for password verification in accordance with an embodiment of the present invention.

FIG. 5 illustrates another example flowchart for verifying an input password in accordance with an embodiment of the present invention.

FIG. 6 illustrates an example diagram block of a password verification environment in accordance with an embodiment of the present invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

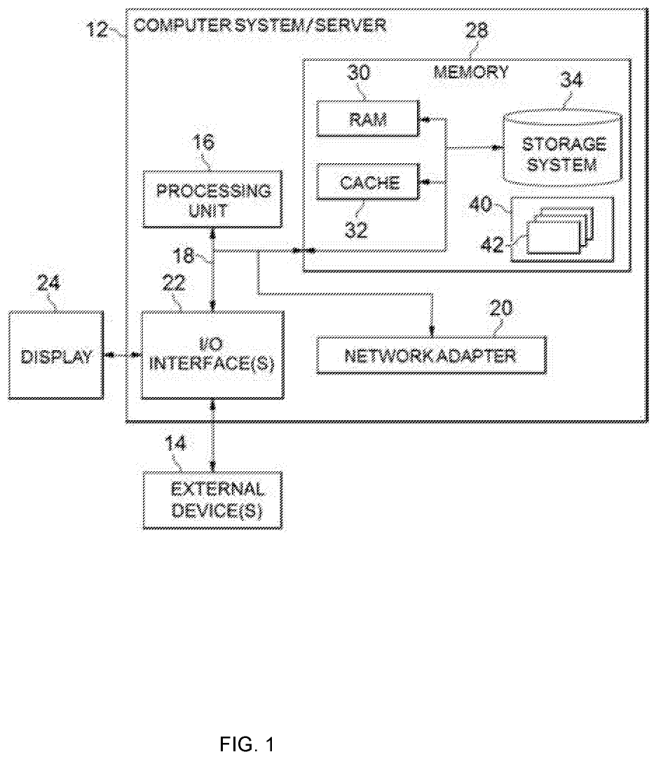

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components can be used in conjunction with computer system/server 12. Examples, include, but are not limited to: microcode, device drivers, redundant processing units, external disk drive arrays, RAID systems, tape drives, and data archival storage systems, etc.

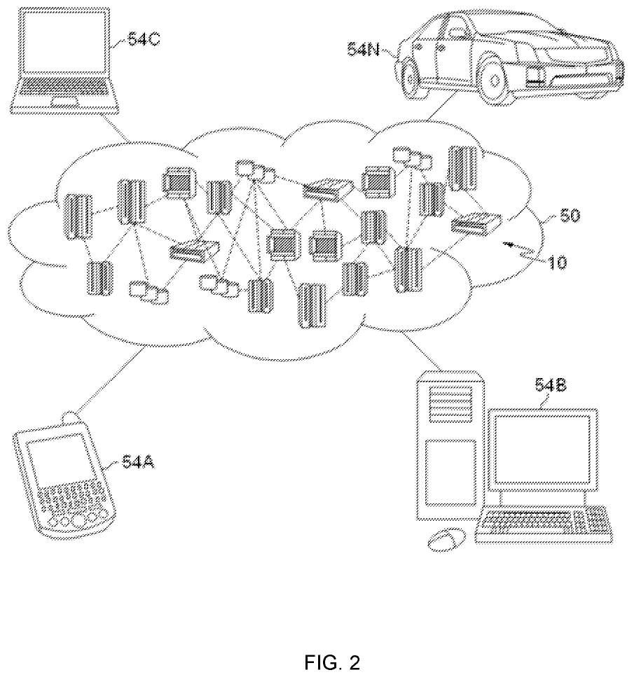

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

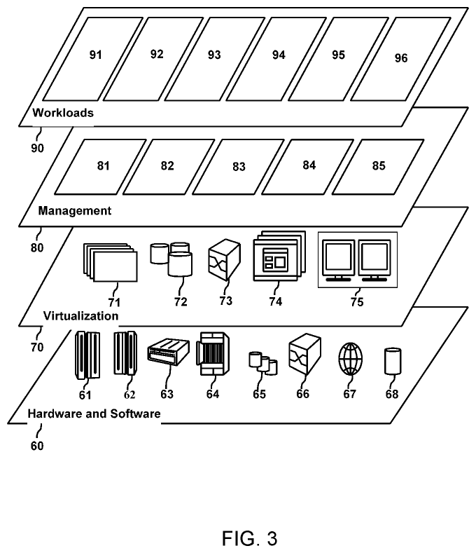

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and password verification 96.

When a user goes to a swimming pool or beach, it would be inconvenient for the user to carry a mobile phone, cash or a bank card, but there can still be a need for the user to spend money on something like drinking, deck chairs, etc. When a user goes out for an evening running, it is better to take as few items as possible. But the user may still need to spend money on something, like drinking or food, in a grocery. When a user plans to take a shared bike which usually requires the user to use a smartphone to scan barcode attached in the shared bike, if the smartphone will be out of power soon, it would bring trouble for the user to pay for the shared bike.

Embodiments of this invention can be used to address a problem brought by above situations by registering a preset password in advance with at least one condition for applying the preset password, so that the user can access a service (for example shared bike) or buy a product (for example buying a beverage at a grocery) by inputting an input password later on without necessity of any smartphone, cash or bank card. The embodiments can be especially useful for micro payment, which normally imposes restrictions on payment with reduced requirement on security level.

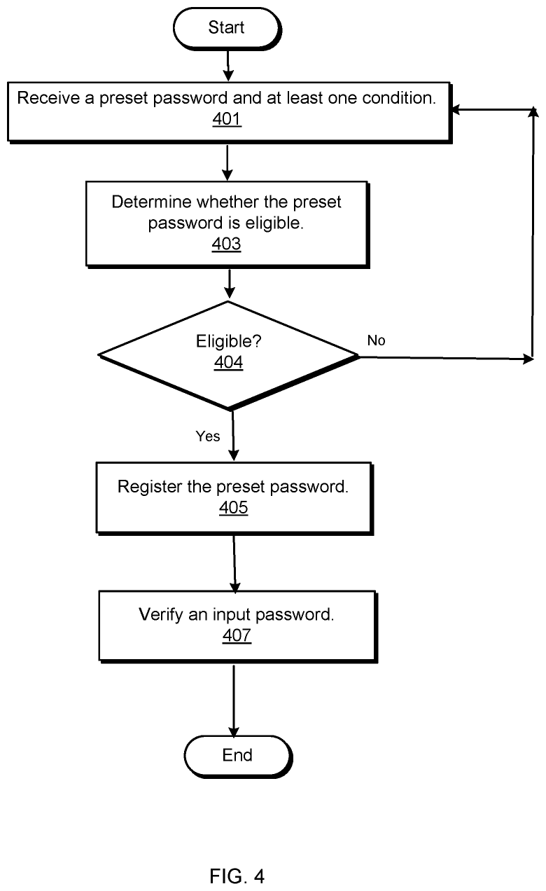

With now reference to FIGS. 4-6, embodiments of the invention can be illustrated in further detail.

FIG. 4 illustrates an example flowchart for password verification. At step 401, a preset password and at least one condition for applying the preset password is received from a device of a user. The device of the user can be a hardware device like a smartphone, a computer, etc. or a software module like an application. The preset password can be for example a simple numeric string (e.g. “2018”), a character string (e.g. “abcdefg”), and so on. The user may tend to use a simple password because this can be easy to remember. Since the simple password is used together with its condition (for example, the simple password is only valid in certain area), issues brought by password conflict (i.e., two users set the same preset password) can be resolved, at least in part, because different simple passwords can be valid for different areas, different time durations, or different vendors. For example, the same password “2018” can be used in building A for user A and be used in building B for user B, or from 1:00 pm-2:00 pm for user A and be used from 3:00 pm-4:00 pm for user B. Similarly the same password “2018” can be used for making purchases from grocery A for user A, and for user B to make purchases from grocery B.

The preset password comprises identification information of the user. An authentication service may require a user to input both identification information as well as a password. For example, when a user attempts to access an email system, the user can be required to input both an account (e.g. “cat”) and a password (e.g. “2018”). Embodiments of present invention can include or exclude the identification information in the preset password. Once the identification information is included in the preset password, the preset password can become longer than that without the identification information. One example of the identification information can be the smartphone number of the user. The user may be required to input both a smartphone number (e.g. “12345678”) as well as a password (e.g. “2018”) together (e.g. enter 8 digits smartphone number and 4 digits password consecutively in one input box) or separately (e.g. enter 8 digits smartphone number and 4 digits password separately in two different input boxes) for accessing the email system. It is noted that other identification information can also be used as well.

The at least one condition comprises, alone or in combination: a time period limitation that defines both beginning and end time of a time period, a geographic limitation, a vendor's limitation, a payment amount limitation, and payment times limitation. The condition is predefined together with the preset password, so that preset password can only be used when the condition is satisfied.

Table 1 below illustrates five conditions, wherein the time period limitation, “8:00 pm-9:00 pm, 2018/9/3”, means that the preset password can only be used during “8:00 pm-9:00 pm” on Sep. 3, 2018. Additionally, the time period limitation can also be “8:00 pm-9:00 pm on everyday”, or “8:00 pm-9:00 pm since Monday to Friday”, etc.

The geographic limitation, “area A”, in Table 1, means the preset password can only be used in area A. Furthermore, “area A” can be illustrated by geographic coordinates, building/location's name, postal code, etc.

The vendor's limitation, “grocery 1, shared bike company 2”, means the preset password can only be used for buying things from grocery 1 or for enjoying the service provided by the shared bike company 2. Additionally, the vendor's limitation can also be used to describe a vendor that is excluded from payment, i.e., a black list.

The payment amount limitation, “10 USD/payment”, in Table 1, means the preset password can only be used for a single payment below or equal to 10 USD. The payment amount limitation can also be used to restrict the total amount which the user is allowed to be spend. For example, “100 USD in total” means no matter how many times of single payments, the total amount allowed under the preset password cannot exceed 100 USD.

The payment times limitation, “5 times”, in Table 1, means the preset password can only be used for payments of 5 times.

TABLE 1

| | Time | | | Payment | Payment |
|---|---|---|---|---|---|
| | period | Geographic | Vendor's | amount | times |
| Condition | limitation | limitation | limitation | limitation | limitation |
| Limitation | 8:00pm- | Area A | Grocery 1, | 10 | 5 times |
| | 9:00pm, | | Shared | USD/payment | |
| | 2018 Sep. 3 | | bike | | |
| | | | company 2 | | |

It is noted that any of the above conditions can be used together with other condition(s). It should also be noted that other conditions not being illustrated in Table 1 can also be used to achieve the purpose of embodiments of this invention.

At step 403 of FIG. 4, it is determined whether the preset password is eligible. Only the eligible preset password proposed by the user can be registered at step 405. And only eligible preset password can be used later on for password verification.

Once a new preset password is received at step 401, it can be compared with all existing preset passwords which have been registered. If the current new preset password is unique, then it is eligible for use. Otherwise, the new preset password is not eligible due to password conflict.

Further, the new preset password can be compared with existing preset passwords to determine whether it is unique within: time range, geographic range, and vendor's range. In order to keep the preset password as simple as possible and as easy as possible, it would not be necessary to require the preset password being absolutely unique.

Instead, so long as the password can be unique within a certain range, then the password can be treated as “unique”. The ranges are determined based on previously registered conditions. In accordance with an embodiment of this invention, the time range excludes all the limitations of previously registered conditions. For example, “2018” has been registered by user A for using during a time period of 8:00 pm-9:00 pm on Sep. 3, 2018. When user B tries to register “2018” as another preset password for being used during 10:00 am-11:00 am on Sep. 3, 2018, then the preset password, “2018”, received from the user B can be determined as eligible, as it will not create a conflict with the preset password “2018” received from user A, because both “2018” are valid for different time periods.

For another example, “2018” has been registered by user A as being valid in area I. When a user B intends to register “2018” as another preset password valid in area II, then the preset password, “2018” received from the user B can be determined as eligible, as it will not create a conflict with the preset password “2018” received from the user A, because they are both valid for different geographical areas.

For yet another example, “2018” has been registered by user A as being valid for vendor I. When a user B intends to register “2018” as another preset password valid for vendor II, then the preset password, “2018” received from the user B can be determined as eligible, as it will not create a conflict with the preset password “2018” received from the user A, because they are both valid for different vendors.

In accordance with another embodiment of this invention, the time range excludes all the limitations of previously registered conditions with some buffer. For example, “2018” has been registered by user A for use during a time period of 8:00 pm-9:00 pm on Sep. 3, 2018. When user B tries to register “2018” as another preset password for use during 9:00 pm-10:00 pm on the same day, the preset password, “2018”, received from the user B can be determined as ineligible, because the start time of the time limitation 9:00 pm-10:00 pm is the same as the end time of previously registered time limitation 8:00 pm-9:00 pm, which may result in a conflict. A time buffer parameter (10 minutes for example) can be set to require adequate separation between the current time period limitation and all previously registered time period limitations. For example, if the user B registers “2018” as a preset password for uses during 9:10 pm-10:00 pm, then the preset password can be determined as eligible. Similarly, a geographic buffer (1 kilometer for example) can be set to require current geographic limitation being far enough away from all previously registered geographic limitations, or a certain vendor's buffer (affiliates for example) can be set to require current vendor's limitation being far enough away from all previously registered vendor's limitations (e.g. once a preset password has been registered for vendor A, no same preset password can be registered for vendor A and affiliates thereof).

It should be noted that time range, geographic range, vendor's range can be used in combination or separately. Also other ranges can be used to determine whether the preset password is unique.

Responsive to the received preset password being not unique, the user can be further asked to improve the preset password with or without notice of why the current preset password is not unique. For example, a notice like “Your proposed password is not unique during 8:00 pm-9:00 pm on Sep. 3, 2018”, or “Your proposed password is not unique in area I” or “Your proposed password is not unique for vendor I”, can be presented further with the user. So that the user might know how to improve the preset password or corresponding condition associated with the preset password.

The step 403 can further comprise a step to determine whether the preset password is strong enough. For example, a rule can require the minimum password digits (for example, 4 digits). For another example, the rule can require the password being combined by both number(s) and letter(s). Responsive to the received preset password being not strong enough, the user can be further asked to improve the preset password with or without notice of the rule required for the preset password.

At step 405, responsive to the preset password being eligible, the preset password is registered together with the at least one condition. For example, the registered information is shown as Table 2 below includes the preset password (“2018”), time period limitation (“8:00 pm-9:00 pm, 2018/9/3”) and geographic limitation (“area A”). It should be noted Table 2 is only provided for illustration purpose. There is no limitation regarding to the storing format or data structure as to how the preset password and condition combination is registered.

TABLE 2

| | Condition(s) | |
|---|---|---|
| Preset password | Time period limitation | Geographic limitation |
| 2018 | 8:00pm-9:00pm, 2018 Sep. 3 | Area A |

At step 407, an input password from a device of a vendor (e.g. a device in a shared bike or a grocery, etc.) can be verified based on the preset password. The input password can be inputted by the user on a hardware device or a software application provided by a vendor. The input password can be then compared with the preset password for verification, details of which is illustrated hereinafter. The device from the vendor can be any hardware or software that is deployed in the vendor side.

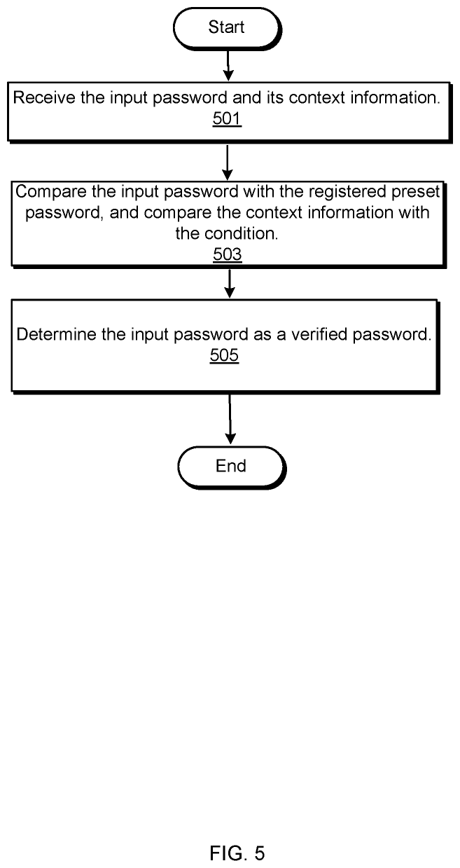

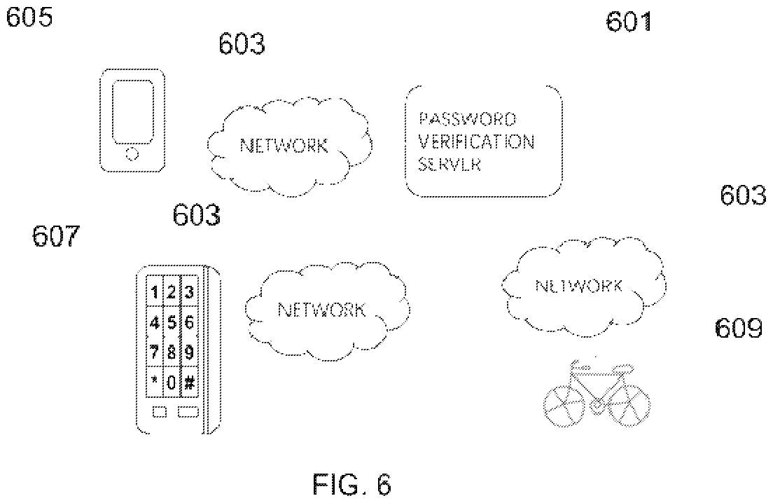

FIG. 5 illustrates another example flowchart for verifying an input password. At step 501, the input password can be received together with its context information. The context information can comprise: verification time, verification location, vendor's identification information, payment amount, and payment times. The context information collected can correspond to the received condition. For example, when the received condition includes time period limitation, the context information collected can include verification time. For another example, when the received condition includes geographic limitation, the collected context information can include a verification location. A table that maps between the condition and the context information is shown as below in Table 3. The context information is collected from the device of the vendor while the condition is collected from the device of the user. The device of the vendor can be enabled with functions to collect all necessary information consistent with the conditions set in the device of the user. Only when the context information meets the condition previously determined by the user, can the input password be verified. The context information can be obtained from a device of a vendor. Some context information like verification time, can also be obtained from a password verification server which will be further illustrated with reference to FIG. 6.

TABLE 3

| Condition | Context Information |
|---|---|
| time period limitation | verification time |
| geographic limitation | verification location |
| vendor's limitation | vendor's identification information |
| payment amount limitation | payment amount |
| payment times limitation | payment times |

At step 503, the input password is compared with the registered preset password, and the context information of the input password is compared with the condition(s) of the registered preset password. For example, if the input password is “2018”, it will be compared with all preset password(s) previously registered. Responsive to a preset password “2018” being found, the condition associated with the preset password can also be evaluated. The condition can be, for example, time period limitation “8:00 pm-9:00 pm, 2018/9/3” and geographic limitation “Area A”. The context information received (for example, verification time “8:30 pm, 2018/9/3”, and verification location “building Z in Area A”), is then compared with the condition of the preset password.

At step 505, responsive to the input password being matched with the preset password, and the context information of the input password meeting the condition, the input password can be determined as a verified password. Additionally, a verification result, like “pass”, is then sent back to the vendor. The vendor can, therefore, permit the business transaction to begin, based on the verification result. The business transaction includes providing a service and selling a product.

FIG. 6 illustrates an example diagram block of a password verification environment. Usually when a rider wants to ride a shared bike 609, the rider needs to use a smartphone 605 to scan a barcode attached on the shared bike 609 to unlock it and pay a fee. But when the smartphone 605 will be out of power soon, the rider can register a preset password in advance (when the smartphone 605 still has power) for using in an area near, for example, the rider's office, so that when the rider's smartphone 605 is off, he can still ride the shared bike 609 near his/her office by inputting the input password and get it verified. A hardware device or a software application that is installed on the shared bike 609 receives the input password and sends it back to the password verification server 601 for verification via the network 603. Once a positive feedback is returned from the password verification server 601 via the network 603, i.e., the input password is verified, the shared bike 609 can accept service request from the rider.

In another example, a tourist intends to go to a beach or pool, or other tourist venue, without carrying a smartphone 605 or cash or any kind of bank card. The tourist can register a preset password in advance, wherein the preset password can be used based on certain condition. For example, the condition can specify that the preset password can be only valid in the beach or pool area, or can limit ability to purchase tickets to amusement rides, and further can limit validity for next hour for payment under 100 USD in total. This cashless payment plan can enable the tourist to pay for a drink or a deck chair, or otherwise enjoy an amenity at a tourist destination, such as an amusement park. Additionally, through this cashless payment plan, the tourist may tend to enhance his personal security when traveling in unknown or unfamiliar areas. A hardware device 607 or a software application should be installed in the grocery, or around the tourist venue, to receive the input password and send it back to the password verification server 601 together with the context information (like verification time, verification location, payment amount) for verification via network 603. Once a positive feedback is returned from the password verification server 601 via the network 603, i.e., the input password is verified, the tourist can access the amenities at the tourist location.

Additionally, an amount of payment can be deducted from a designated account of the user based on the condition received when the preset password is registered at the password verification server (Step 405 of FIG. 4). For example, if there is total payment amount limitation received as a condition for applying the preset password, then a certain amount of payment, equaling to the total payment amount limitation, can be deducted from an account of the user. For another example, if there is no total payment amount limitation received as a condition, then a predefined amount of payment, which is decided based on other condition, like time period limitation (e.g. the more time duration is set in the time period limitation, the more predefined amount of payment is required), geographic limitation (the larger the scope of geographic limitation is set, the more predefined amount of payment is required), etc., can be determined and deducted from the user.

As part of the registration process, an association (link) can be built between a payment account of the user and the password verification server 601 in FIG. 6, so that responsive to the verification being passed, the payment can be automatically deducted from the payment account of the user. However, the disclosure can be implemented in various manners other than the ones described above regarding to deduction of payment.

Although embodiments of this invention use smartphone as an example for registering the preset password, it can be noted that other smart, Internet-enabled devices such as tablet computers, and wearable technology, computer, etc. can also be used without limitation.

It should be also noted that the method or system of password verification according to embodiments of this disclosure can be implemented by computer system/server 12 of FIG. 1.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for password verification, comprising:
receiving a new preset password, comprising a character string and/or a numeric string, at least one condition, and at least one limitation associated with the at least one condition, at a password verification server;
based on the combined character string and/or the numeric string, each of the at least one condition, and each of the at least one limitation being unique on the password verification server, registering the preset password; and
in response to receiving a registered preset password, verifying by the password verification server, that the registered preset password is verified for a use.

2. The method of claim 1, wherein the at least one condition comprises: time period limitation, geographic limitation, vendor's limitation, payment amount limitation, and payment times limitation.

3.-5. (canceled)

6. The method of claim 1, further comprising:
receiving the character string and/or the numeric string at a device of a vendor;
sending context information and the character string and/or a numeric string from the device of the vendor to the password verification server, wherein the context information corresponds to the at least one condition;
searching the password verification server for a matching character string and/or a numeric string;
in response to locating the matching character string and/or a numeric string, comparing, by the password verification server, the context information with the at least one condition of the at least one registered preset password; and
responsive to the context information meeting the at least one condition of the registered preset password, verifying the password for use.

7. The method of claim 6, wherein the context information comprises: verification time, verification location, vendor's identification information, payment amount, and payment times.

8.-9. (canceled)

10. A computer system for password verification, the system comprising:
one or more processors;
a memory coupled to at least one of the processors;
a set of computer program instructions stored in the memory and executed by at least one of the processors in order to perform actions of:
receiving a new preset password, comprising a character string and/or a numeric string, at least one condition, and at least one limitation associated with the at least one condition, at a password verification server;
based on the combined character string and/or the numeric string, each of the at least one condition, and each of the at least one limitation being unique on the password verification server, registering the preset password; and
in response to receiving a registered preset password, verifying by the password verification server, that the registered preset password is verified for a use.

11. The computer system of claim 10, wherein the at least one condition comprises, alone or in combination: time period limitation, geographic limitation, vendor's limitation, payment amount limitation, and payment times limitation.

12. (canceled)

13. The computer system of claim 10, wherein the new preset password is unique when the character string and/or the numeric string matches a character string and/or a numeric string on the password verification server but each of the limitations associated with the at least one condition is unique within at least one of the following range: time range, geographic range, vendor's range.

14. The computer system of claim 10, comprising:
receiving the character string and/or the numeric string at a device of a vendor;
sending context information and the character string and/or a numeric string from the device of the vendor to the password verification server, wherein the context information corresponds to the at least one condition;
searching the password verification server for a matching character string and/or a numeric string;
in response to locating the matching character string and/or a numeric string, comparing, by the password verification server, the context information with the at least one condition of the at least one registered preset password; and
responsive to the context information meeting the at least one condition of the registered preset password, verifying the password for use.

15. The computer system of claim 10, wherein a transaction executes based on the device of the vendor receiving a positive verification result from the password verification server.

16. A computer program product for password verification, comprising a computer readable storage medium having program instructions embodied therewith, the program instructions being executable by one or more processors of a computer to cause the computer to:
receive a new preset password, comprising a character string and/or a numeric string, at least one condition, and at least one limitation associated with the at least one condition, at a password verification server;
based on the combined character string and/or the numeric string, each of the at least one condition, and each of the at least one limitation being unique on the password verification server, register the preset password; and
in response to receiving a registered preset password, verify by the password verification server, that the registered preset password is verified for a use.

17. The computer program product of claim 16, wherein the at least one condition comprises: time period limitation, geographic limitation, vendor's limitation, payment amount limitation, and payment times limitation.

18. (canceled)

19. The computer program product of claim 16, wherein the new preset password is unique when the character string and/or the numeric string matches a character string and/or a numeric string on the password verification server but each of the limitations associated with the at least one condition is unique within: time range, geographic range, and vendor's range.

20. The computer program product of claim 16, further comprising:
receiving the character string and/or the numeric string at a device of a vendor;
sending context information and the character string and/or a numeric string from the device of the vendor to the password verification server, wherein the context information corresponds to the at least one condition;
searching the password verification server for a matching character string and/or a numeric string;
in response to locating the matching character string and/or a numeric string, comparing, by the password verification server, the context information with the at least one condition of the at least one registered preset password; and
responsive to the context information meeting the at least one condition of the registered preset password, verifying the password for use.

21. The method of claim 6, wherein the context information is collected from the device of the vendor, and the at least one condition is collected from either a device of the user or from the password verification server.

22. The computer system of claim 14, wherein the context information is collected from the device of the vendor, and the at least one condition is collected from either a device of the user or from the password verification server.
